(19) United States
(12) Patent Application Publication
(10) Pub. No.: US 2009/0147832 A1
(43) Pub. Date: Jun. 11, 2009

(54) Wireless communication system and method

(75) Inventors: Jong Won Kim, Daejeon (KR); Sangsung Choi, Daejeon (KR); Kwang Roh Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/155,837

(22) Filed: Jun. 10, 2008

(30) Foreign Application Priority Data
Dec. 10, 2007 (KR) 10-2007-0127610

(51) Int. Cl. H04B 1/707

(52) U.S. Cl. 375/144; 375/E01.002

(57) ABSTRACT

A wireless communication system includes a heterogeneous wireless station for transmitting and receiving a heterogeneous wireless station signal; and a detection and avoidance device for detecting the heterogeneous wireless station signal, and for transmitting and receiving an ultra-wideband signal, the ultra-wideband signal with a reduced output or the ultra-wideband signal shifted to another ultra-wideband or ultra-wideband group in order to prevent interference with the heterogeneous wireless station based on a predetermined level. Further, a communication method includes receiving a heterogeneous wireless station signal; converting the heterogeneous wireless station signal into tone-nulling elements based on a predetermined level; receiving the tone-nulling elements, and generating an ultra-wideband signal or reducing an output of the ultra-wideband signal; and changing a time frequency number of the ultra-wideband signal based on the values of the tone-nulling elements to selectively shift to another band of the band group or another band group.

### CROSS-REFERENCE(S) TO RELATED APPLICATIONS

The present invention claims priority of Korean Patent Application No. 10-2007-0127610, filed on Dec. 10, 2007, which is incorporated herein by reference.

### FIELD OF THE INVENTION

The present invention relates to a wireless communication system and method; and, more particularly, to a wireless communication system and method for detecting a signal from a heterogeneous wireless station, reducing an output of an ultra-wideband (UWB) signal, and avoiding interference with the ultra-wideband signal in an ultra-wideband communication environment.

### BACKGROUND OF THE INVENTION

In recent years, ultra-wideband (UWB) communication has been actively studied, which coexists with conventional wireless communication service and realizes high-speed wideband wireless communication without needing separate frequency resource, as well known.

In particular, ultra-wideband communication in which data is transmitted using a pulse as very short as several nano seconds has different characteristics from conventional narrow band communication, that is, advantages such as a wide frequency band and a low transmit power density resulting from signal transmission using a pulse; fast data transmission resulting from use of a widebandwidth; relatively low power consumption; multiple access; and even communication in a noise band.

The ultra-wideband communication will be primarily applied to, for example, local area communication operating in a distance less than 10 m. The ultra-wideband communication attracts attentions as a next generation local area communication technology because of a faster data transmission capability, as compared to conventional local area communications such as Bluetooth, Zigbee or the like.

However, the ultra-wideband communication is highly likely to collide with other wireless communication networks due to its use of a widebandwidth. Accordingly, each country regulates a limit of an emitted power in order to prevent an ultra-wideband signal from interfering with existing channels, so that power is kept at or smaller than a reference level in an ultra-wideband communication band where interference with a service band of a specific wireless communication network occurs.

Meanwhile, as a conventional scheme of avoiding interference with an ultra-wideband signal, disclosed is that a null tone band of the ultra-wideband signal is shifted to a band where interference with a wireless communication network signal occurs, thereby preventing interference between the ultra-wideband signal and the other wireless communication network signal, and when a band is shifted to a null tone band of an ultra-wideband signal, only one tone serving as a DC term is changed into a null tone in accordance with the shift, thereby minimizing data loss in avoiding the interference with the ultra-wideband signal.

However, in conventional interference avoidance schemes, there is no function for detecting a signal from a heterogeneous wireless station; a frequency band, in which an output of an ultra-wideband signal is allowed to be reduced, is as narrow as up to 20 MHz; and there is no function for shifting to another ultra-wideband or another ultra-wideband group.

### SUMMARY OF THE INVENTION

It is, therefore, a primary object of the present invention to provide a wireless communication system and method capable of detecting a signal from a heterogeneous wireless station in order to prevent interference with a heterogeneous wireless station in communication.

It is another object of the present invention to provide a wireless communication system and method capable of reducing an output of an ultra-wideband signal in a specific frequency band when a signal from a heterogeneous wireless station is equal to or greater than a predetermined level.

It is still another object of the present invention to provide a wireless communication system and method capable of shifting to another ultra-wideband or another ultra-wideband group in order to prevent interference with a heterogeneous wireless station operating in a frequency band exceeding a specific frequency.

In accordance with one aspect of the invention, there is provided wireless communication system operating in an ultra-wideband (UWB) communication environment, including a heterogeneous wireless station for transmitting and receiving a heterogeneous wireless station signal; and one or more detection and avoidance devices for detecting the heterogeneous wireless station signal while ultra wideband communication operating, and for transmitting and receiving an ultra-wideband signal, the ultra-wideband signal after an output thereof being reduced or the ultra-wideband signal after being selectively shifted to another ultra-wideband or another ultra-wideband group in order to prevent interference with the heterogeneous wireless station based on a predetermined level.

The detection and avoidance device may include a transmitting and receiving antenna for receiving the heterogeneous wireless station signal from the heterogeneous wireless station, and for transmitting and receiving the ultra-wideband signal; a signal detecting unit for receiving the heterogeneous wireless station signal via the transmitting and receiving antenna to detect the heterogeneous wireless station signal, and for converting the heterogeneous wireless station signal into tone-nulling elements for a heterogeneous wireless station frequency based on the predetermined level; and an interference avoiding unit for receiving the tone-nulling elements, and for, based on values of the tone-nulling elements, generating the ultra-wideband signal as a normal signal to transmit the ultra-wideband signal via the transmitting and receiving antenna; reducing the output of the ultra-wideband signal by minimizing power of a transmit signal at a frequency of a subcarrier via the transmissing and receiving antenna to transmit the ultra-wideband signal via the transmitting and receiving antenna; or changing a time frequency number (TFC) value of the ultra-wideband signal to selectively shift the ultra-wideband signal to said another band in a corresponding band group or said another band group thereby being transmitted via the transmitting and receiving antenna.

It is preferable that the signal detecting unit has a radio frequency (RF) receiving part for receiving the heterogeneous wireless station signal via the transmissing and receiving antenna, and for RF-demodulating the heterogeneous wireless station signal into a baseband analog signal; an analog-digital converting (ADC) part for receiving the analog signal and converting the analog signal into digital data; a fast Fourier transforming (FFT) part for receiving the digital data and performing FFT on the digital data; a frequency detecting part for receiving the fast Fourier transformed data from the FFT part, and for converting the FFT data into heterogeneous wireless station frequency data by selectively setting values of subcarriers corresponding to the heterogeneous wireless station signal based on the predetermined level; and a MAC receiving part for receiving the heterogeneous wireless station frequency data, selectively setting values of tones for the heterogeneous wireless station signal based on the predetermined level, converting the heterogeneous wireless station frequency data into the tone-nulling elements, and then sending the tone-nulling elements to the interference avoiding unit.

Further, it is preferable that the interference avoiding unit has a MAC transmitting part for receiving ultra-wideband transmit data from an MAC upper layer and the tone-nulling elements from the MAC receiving part, for converting the ultra-wideband transmit data into ultra-wideband MAC transmit data, and, based on values of the tone-nulling elements, for converting the tone-nulling elements into transmit data of the tone-nulling elements for the heterogeneous wireless station frequency to send the transmit data; or generating and sending a channel number corresponding to said another band in the band group or said another band group to be shifted to; a data converting part for receiving the ultra-wideband MAC transmit data and performing PLCP processing, scrambling, encoding, puncturing, interleaving, modulating and conversing processes on the ultra-wideband MAC transmit data; an AND operating part for receiving parallel data from the data converting part and the transmit data of the tone-nulling elements from the MAC transmitting part, and performing an AND function depending on each subcarrier channel; an inverse fast Fourier transforming (IFFT) part for receiving IFFT input data from the AND operating part, performing IFFT on the IFFT input data, and generating the ultra-wideband signal or reducing the output of the ultra-wideband signal by minimizing transmit signal power at a frequency of a subcarrier based on the values of the tone-nulling element; a digital-analog converting (DAC) part for receiving the IFFT data from the IFFT part and converting the digital data into an analog signal; and an RF transmitting part for receiving the analog signal and the channel number from the MAC transmitting part, for RF-modulating the analog signal, converting the RF-modulated analog signal into the ultra-wideband signal based on a frequency band and a transmission speed, and transmitting the ultra-wideband signal via the transmitting and receiving antenna, and for using the channel number to change the TFC value so that the ultra-wideband data are shifted to said another band of the band group or said another band group to thereby be transmitted via the transmitting and receiving antenna.

Further, it is preferable that the data converter has a PLCP processor for receiving the ultra-wideband MAC transmit data, and converting the ultra-wideband MAC transmit data into PLCP processor data in a format of an ultra-wideband PHY Protocol Data Unit (PHY PPDU) frame; a scrambler for receiving the PLCP processor data and converting the PLCP processor data into a random code sequence; an encoder for Reed-Solomon (RS)-encoding and convolution-encoding the scrambled data from the scrambler; a puncturer for receiving the encoded data from the encoder, and performing a puncturing function to increase a code rate by regularly omitting a portion of the convolution-encoded data depending on a transmission speed; an interleaver for receiving the punctured data from the puncturer, and performing a bit-interleaving function to arrange an order of a symbol sequence and a data sequence in a predetermined unit in order to normally correct a burst error resulting from an instantaneous noise; a modulator for receiving interleaved data from the interleaver and performing a Quadrature Phase Shift Keying (QPSK) modulation function or a Dual Carrier Modulation (DCM) function depending on the transmission speed; and a converter for receiving the modulated data from the modulator and converting the serial data into parallel data.

The encoder may be provided with an RS encoder for receiving the scrambled data and RS-encoding the scrambled data to normally correct the burst error resulting from the instantaneous noise; and a convolution encoder for receiving the RS-encoded data from the RS encoder and convolution-encoding the RS-encoded data to normally correct a random error.

In accordance with another aspect of the invention, there is provided a communication method in a wireless communication system in an ultra-wideband (UWB) communication environment, the method including receiving a heterogeneous wireless station signal from a heterogeneous wireless station to detect the heterogeneous wireless station signal; converting the heterogeneous wireless station signal into tone-nulling elements for a frequency of the heterogeneous wireless station signal based on a predetermined level, corresponding to the UWB communication environment; receiving the tone-nulling elements, and thereafter, based on values of the tone-nulling elements, generating an ultra-wideband signal as a normal signal to transmit the ultra-wideband signal via a transmitting and receiving antenna, or reducing an output of the ultra-wideband signal by minimizing transmit signal power at a frequency of a subcarrier to transmit the ultra-wideband signal having the reduced output via the transmitting and receiving antenna; and changing a time frequency number (TFC) of the ultra-wideband signal based on the values of the tone-nulling elements to selectively shift the ultra-wideband signal to another band of a corresponding band group or another band group to transmit the ultra-wideband signal.

Preferably, the receiving the heterogeneous wireless station signal includes RF-demodulating the heterogeneous wireless station signal into a baseband analog signal; converting the RF-demodulated analog signal into digital data; performing fast Fourier transform (FFT) function on the digital data; and converting the FFT data into heterogeneous wireless station frequency data by selectively setting values of subcarriers corresponding to the heterogeneous wireless station signal based on the predetermined level.

The converting the heterogeneous wireless station signal may selectively set values of tones for the heterogeneous wireless station signal based on the predetermined level, and then converting the heterogeneous wireless station frequency data into the tone-nulling elements for the heterogeneous wireless station frequency.

It is preferable that the receiving the tone-nulling elements includes receiving ultra-wideband transmit data from an MAC upper layer and the tone-nulling elements; converting the ultra-wideband transmit data into ultra-wideband MAC transmit data; and converting the tone-nulling elements into transmit data of tone-nulling elements to send the transmit data of tone-nulling elements or generating and sending a channel number corresponding to said another band in the band group or said another band group to be shifted to based on the values of the tone-nulling element; performing PLCP processing, scrambling, encoding, puncturing, interleaving, modulating and conversing processes on the ultra-wideband MAC transmit data; receiving the transmit data of the tone-nulling elements and performing an AND function depending on each subcarrier channel; performing inverse fast Fourier transform (IFFT) on the IFFT input data, and generating the ultra-wideband signal or reducing the output of the ultra-wideband signal by minimizing transmit signal power at a frequency of a subcarrier based on the values of the tone-nulling elements; and converting the digital data into an analog signal, RF-modulating the analog signal through the channel number, converting the analog signal into the ultra-wideband signal based on a frequency band and a transmission speed, and transmitting the ultra-wideband signal.

Further, the changing a time frequency number may use the channel number to change the TFC value so that the ultra-wideband data are shifted to said another band of the band group or said another band group to thereby be transmitted.

The present invention detects a signal from a heterogeneous wireless station, and, when the signal equal to or greater than a predetermined level from the heterogeneous wireless station is detected, it reduces an output of an ultra-wideband signal in a frequency band of up to 170 MHz and shifts to another ultra-wideband or another ultra-wideband group in order to prevent interference with a heterogeneous wireless station operating in a frequency band exceeding 170 MHz so that an ultra-wideband device does not interfere with the heterogeneous wireless station, unlike conventional methods by which a null tone band of an ultra-wideband signal is shifted to a band where interference with a predetermined wireless communication network signal occurs in order to avoid the interference.

That is, with the present invention, it is possible to detect a signal from a heterogeneous wireless station while operating an ultra-wideband communication, to provide a frequency band as wide as up to 170 MHz in which an output of the ultra-wideband signal is allowed to be reduced, and to shift to another ultra-wideband or another ultra-wideband group in order to prevent interference with a heterogeneous wireless station operating in a frequency band exceeding 170 MHz.

### BRIEF DESCRIPTION OF THE DRAWINGS

The above and other objects and features of the present invention will become apparent from the following description of embodiments given in conjunction with the accompanying drawings, in which:

FIG. 1 is a block diagram illustrating a wireless communication system for ultra-wideband communication in accordance with the present invention;

FIG. 2 is a block diagram illustrating a detection and avoidance device for detecting an ultra-wideband signal and avoiding interference in accordance with an embodiment of the present invention;

FIG. 3 is a block diagram illustrating a signal detecting unit for detecting an ultra-wideband signal in accordance with an embodiment of the present invention;

FIGS. 4a and 4b are block diagrams illustrating an interference avoiding unit for avoiding interference with an ultra-wideband signal in accordance with an embodiment of the present invention;

FIG. 5 illustrates allocation of an ultra-wideband group in accordance with the present invention;

FIG. 6 illustrates a format of an ultra-wideband PHY Protocol Data Unit (PHY PPDU) frame in accordance with the present invention; and

FIG. 7 is a flowchart illustrating a communication process of detecting an ultra-wideband signal and avoiding interference thereof in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

The technical gist of the present invention is that a heterogeneous wireless station signal is received and detected through radio frequency (RF) modulation, analog-digital conversion (ADC), fast Fourier transform (FFT), tone-nulling element conversion and the like; and then, ultra-wideband transmit data is converted to ultra-wideband MAC transmit data to transmit an ultra-wideband signal through physical layer convergence procedure (PLCP) process, scrambling, encoding, puncturing, interleaving, modulating and conversing, AND operating, inverse fast Fourier transforming, digital-analog conversion (DAC), RF modulating and the like in order to avoid interference, whereby the aforementioned problems with the conventional techniques can be solved.

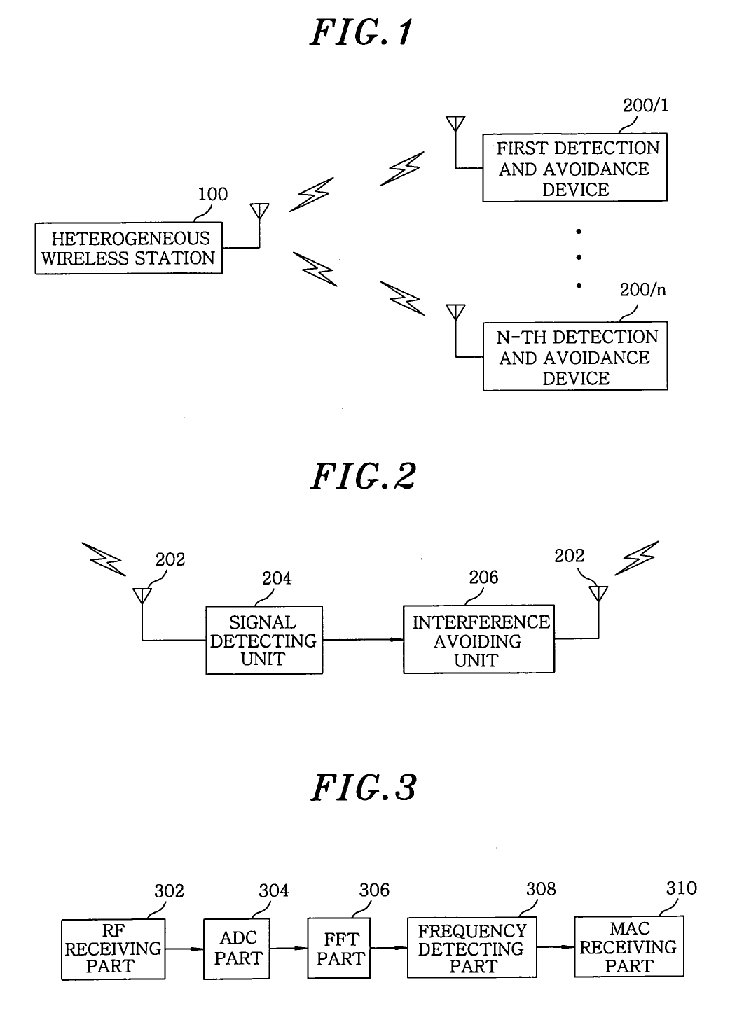

FIG. 1 is a block diagram illustrating a wireless communication system for ultra-wideband communication in accordance with the present invention. The wireless communication system includes a heterogeneous wireless station 100 and first to n-th detection and avoidance devices 200/1 to 200/n. Here, the first to n-th detection and avoidance devices 200/1 to 200/n may include at least one detection and avoidance device, for example, three or five detection and avoidance devices depending on the necessity.

Referring to FIG. 1, examples of the heterogeneous wireless station 100 include a World Interoperability for Microwave Access device (WiMax) using a frequency band in a band group #1, a 4-generation (4G) device, a broadcasting device, a military wireless device, a broadcast relaying device, and a radio-astronomical device. The heterogeneous wireless station 100 transmits and receives a heterogeneous wireless station signal.

The first to n-th detection and avoidance devices 200/1 to 200/n detect a signal from the heterogeneous wireless station 100 while operating an ultra-wideband communication. If the heterogeneous wireless station signal is below a predetermined level, the first to n-th detection and avoidance devices 200/1 to 200/n perform a normal ultra-wideband signal transmission and reception process. If the heterogeneous wireless station signal is equal to or greater than the predetermined level, the first to n-th detection and avoidance devices 200/1 to 200/n reduce an output of the ultra-wideband signal in a frequency band of, for example, up to 170 MHz and shifts to another ultra-wideband or another ultra-wideband group in order to prevent interference with the heterogeneous wireless station 100 operating in a frequency band exceeding, for example, 170 MHz.

The predetermined level is, for example, −80 dBm/MHz in the Republic of Korea and may be determined by a Detect and Avoid (DAA) regulation in other countries. When the first to n-th detection and avoidance device 200/1 to 200/n operating in an ultra-wideband scheme use a WiMedia UWB transceiver of band group #1, a frequency band of 1584 MHz (=528 MHz×3) is used. The frequency band consists of 384 tones and each of the tones has a frequency band of 4.125 MHz.

Further, since up to forty two tones (42×4.125 MHz=173.25 MHz) out of one band group can be nulled in accordance with an international standard for WiMedia, the first to n-th detection and avoidance devices 200/1 to 200/n operating in the ultra-wideband scheme may reduce an output of the ultra-wideband signal to a transmit signal complying with the DAA regulation in each country, and reduce the output in a frequency band of up to 170 MHz (forty two tones) to −70 dBm/MHz or less, for example, in the Republic of Korea. Furthermore, the first to n-th detection and avoidance devices 200/1 to 200/n change a time frequency number (hereinafter, “TFC”) value to perform shifting to another band in band group #1 or another band group #2, #3, #4, #5, or #6, so that interference with the heterogeneous wireless station operating in a frequency band exceeding 170 MHz is prevented.

Meanwhile, FIG. 5 illustrates allocation of an ultra-wideband group in accordance with the present invention. The first to n-th detection and avoidance devices 200/1 to 200/n operating in the ultra-wideband scheme are allocated in accordance with ultra-wideband (UWB) group allocation of the international standard for WiMedia, in which the ultra-wideband group is allocated to band groups #1 to #6 within an ultra-wideband frequency band of 3.1 to 10.6 GHz. Each of band groups #1, #2, #3, #4, and #6 includes three bands and band group #5 includes bands #13 and #14.

Here, each band has a frequency length of 528 MHz. Band #1 ranges from 3168 to 3696 MHz, band #2 ranges from 3696 to 4224 MHz, band #3 ranges from 4224 to 4752 MHz, band #4 ranges from 4752 to 5280 MHz, band #5 ranges from 5280 to 5808 MHz, band #6 ranges from 5808 to 6336 MHz, band #7 ranges from 6336 to 6864 MHz, band #8 ranges from 6864 to 7392 MHz, band #9 ranges from 7392 to 7920 MHz, band #10 ranges from 7920 to 8448 MHz, band #11 ranges from 8448 to 8976 MHz, band #12 ranges from 8976 to 9504 MHz, band #13 ranges from 9504 to 10032 MHz, and band #14 ranges from 10032 to 10560 MHz.

The first to n-th detection and avoidance devices 200/1 to 200/n operating in the ultra-wideband scheme which uses worldwide a radio wave of a frequency band of 3.168 to 4.752 GHz (band group #1) perform a detect and avoid (DAA) function to reduce or to shift an output of the ultra-wideband signal, thereby preventing interference with the heterogeneous wireless station 100.

Meanwhile, FIG. 2 is a block diagram illustrating the detection and avoidance device for detecting an ultra-wideband signal and avoiding interference in accordance with an embodiment of the present invention. Each of the first to n-th detection and avoidance devices 200/1 to 200/n includes a transmitting and receiving antenna 202, a signal detecting unit 204, and an interference avoiding unit 206.

With the fist to n-th detection and avoidance device 200/1 to 200/n being described in detail with reference to FIG. 2, the transmitting and receiving antenna 202 receives a heterogeneous wireless station signal from the heterogeneous wireless station 100, and transmits and receives an ultra-wideband signal.

Further, the signal detecting unit 204 receives the heterogeneous wireless station signal from the transmitting and receiving antenna 202 to detect the heterogeneous wireless station signal. If the heterogeneous wireless station signal is equal to or greater than a predetermined level, the signal detecting unit 204 converts the signal into 384 tone-nulling elements for a heterogeneous wireless station frequency and sends the 384 tone-nulling elements to the interference avoiding unit 206. Here, the 384 heterogeneous wireless station frequency tone-nulling elements correspond to subcarriers of each band of the ultra-wideband signal, tone-nulling (TN) 0 to 127 may be applied to subcarriers of band #1, TN 128 to 255 may be applied to subcarriers of band #2, and TN 256 to 383 may be applied to subcarriers of band #3.

Then, the interference avoiding unit 206 receives the tone-nulling elements for the heterogeneous wireless station frequency from the signal detecting unit 204. For example, if all 384 tone-nulling element values for the heterogeneous wireless station frequency are ones, the interference avoiding unit 206 generates an ultra-wideband signal as a normal signal and sends the ultra-wideband signal to a transmitting and receiving antenna 202. For example, if forty two or less of the 384 tone-nulling element values for the heterogeneous wireless station frequency are zeros, the interference avoiding unit 206 reduces an output of the ultra-wideband signal by minimizing transmit signal power in a frequency of subcarriers corresponding to zero, and sends the resulting ultra-wideband signal to the transmitting and receiving antenna 202. For example, if forty three or more of the 384 tone-nulling element values for the heterogeneous wireless station frequency are zeros, the interference avoiding unit 206 changes a TFC value of the ultra-wideband signal and shifts to another band in the band group #1 or another band group #2, #3, #4, #5, or #6 to thereby send the signal to the transmitting and receiving antenna 202.

On the other hand, FIG. 3 is a block diagram illustrating a signal detecting unit for detecting an ultra-wideband signal in accordance with an embodiment of the present invention. The signal detecting unit 204 includes a radio frequency (RF) receiving part 302, an analog-digital converting (ADC) part 304, a fast Fourier transforming (FFT) part 306, a frequency detecting part 308, and an MAC receiving part 310.

Referring to FIG. 3, the RF receiving part 302 receives a heterogeneous wireless station signal from the transmitting and receiving antenna 202, RF-demodulates the heterogeneous wireless station signal into a baseband analog signal, and sends the RF-demodulated analog signal to the ADC part 304.

The ADC part 304 receives the RF-demodulated analog signal from the RF receiving part 302, converts the analog signal into digital data, and sends the converted digital data to the FFT part 306.

The FFT part 306 receives the digital data from the ADC unit 304, performs fast Fourier transform operation on the digital data, and sends resulting FFT data to the frequency detecting part 308.

The frequency detecting part 308 receives the FFT data from the FFT part 306. Then, among 384 subcarriers within the band group #1, converted into zeros are values of subcarriers corresponding to heterogeneous wireless station signals from the heterogeneous wireless station 100 which are equal to or greater than a predetermined level; and converted into ones are values of subcarriers corresponding to heterogeneous wireless station signals from the heterogeneous wireless station 100 which are less than the predetermined level. Thereafter, the frequency detecting part 308 sends the heterogeneous wireless station frequency data to the MAC receiving part 310.

Subsequently, the MAC receiving part 310 receives the heterogeneous wireless station frequency data from the frequency detecting part 308, converts values of tones corresponding to the heterogeneous wireless station data equal to or greater than the predetermined level into zeros, and converts values of tones corresponding to the heterogeneous wireless station data less than the predetermined level into ones, being converted into 384 tone-nulling elements for the heterogeneous wireless station frequency within the band group #1. Then, the MAC receiving part 310 transmits the tone-nulling elements to the interference avoiding unit 206.

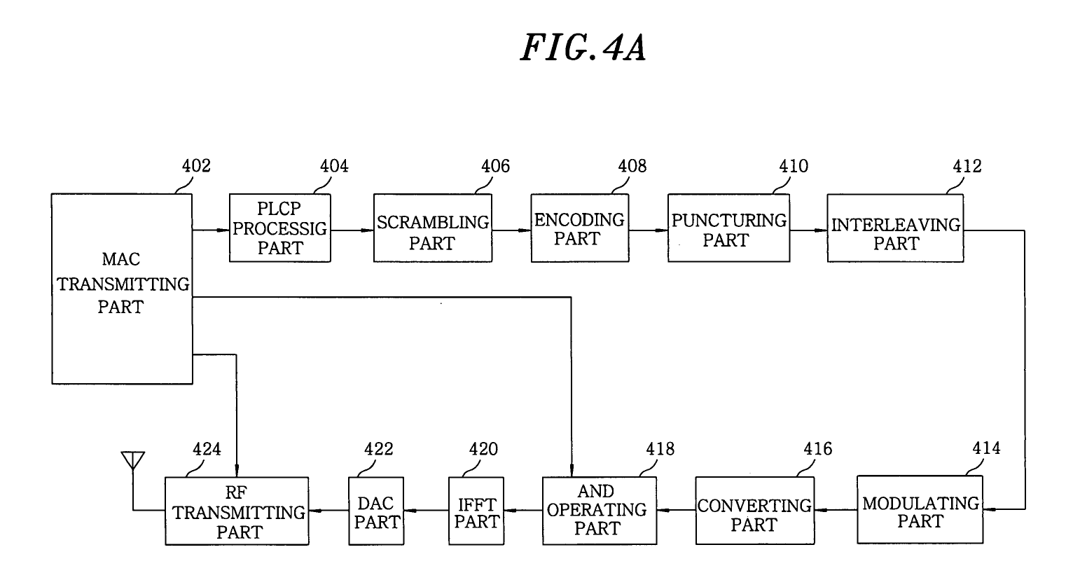

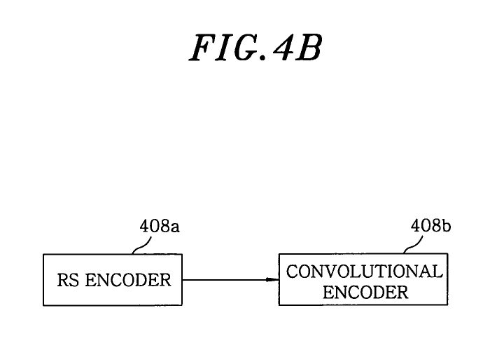

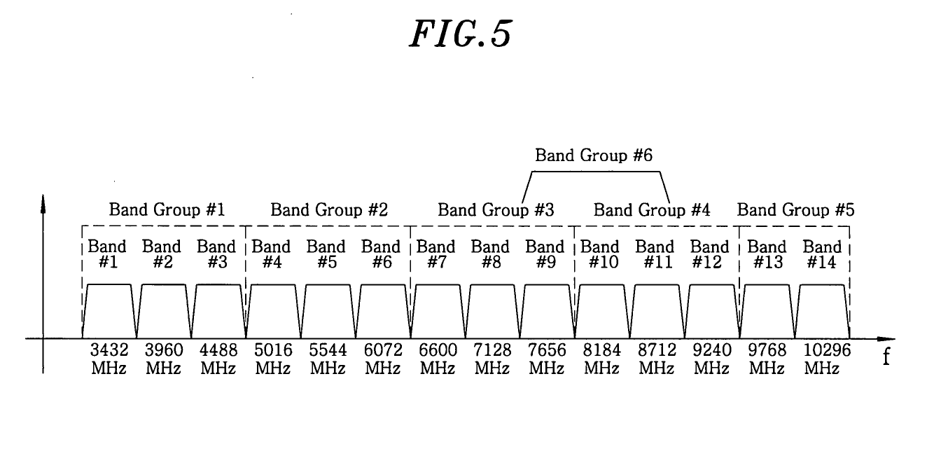

Meanwhile, FIGS. 4a and 4b are block diagrams illustrating an interference avoiding unit 206 for avoiding interference with an ultra-wideband signal in accordance with an embodiment of the present invention. The interference avoiding unit 206 includes an MAC transmitting part 402, a Physical Layer Convergence Procedure (PLCP) processing part 404, a scrambling part 406, an encoding part 408, a puncturing part 410, an interleaving part 412, a modulating part 414, a converting part 416, an AND operating part 418, an inverse fast Fourier transforming (IFFT) part 420, a digital-analog converting (DAC) part 422, and an RF transmitting part 424. The encoding part 408 includes an Reed-Solomon (RS) encoder 408a and a convolution encoder 408b.

Referring to FIGS. 4a and 4b, the MAC transmitting part 402 receives ultra-wideband transmit data from a MAC upper layer and the tone-nulling elements for the heterogeneous wireless station frequency from the MAC receiving part 310. The MAC transmitting part 402 converts the ultra-wideband transmit data into the ultra-wideband MAC transmit data and sends the ultra-wideband MAC transmit data to the PLCP processing part 404. Among the 384 tone-nulling elements for the heterogeneous wireless station frequency, if, for example, forty two or less tone-nulling element values are zeros, the MAC transmitting part 402 converts the tone-nulling elements into transmit data of the tone-nulling elements for the heterogeneous wireless station frequency to thereby be transmitted to the AND operating part 418. Further, if, for example, forty three or more tone-nulling element values are zeros, the MAC transmitting part 402 generates a channel number corresponding to another band in band group #1 or another band group #2, #3, #4, #5, or #6, and sends the channel number, to thereby be transmitted to the RF transmitting part 424.

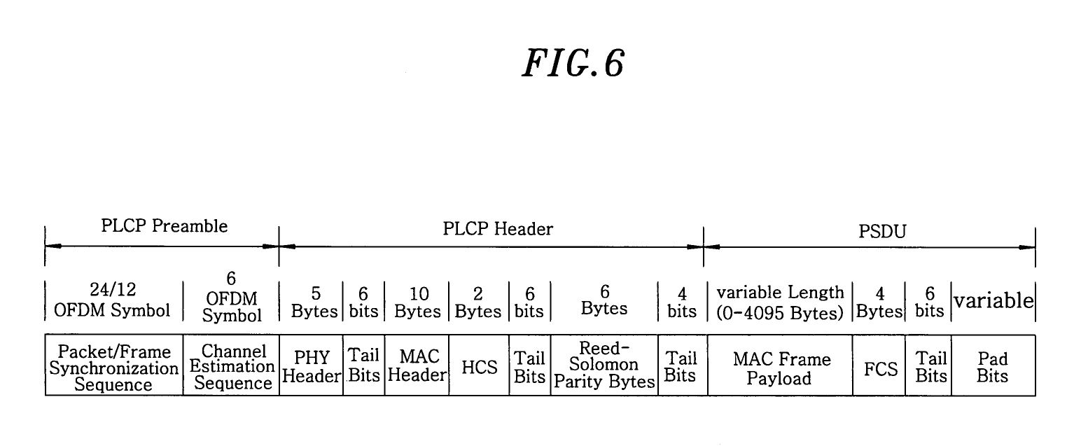

The PLCP processing part 404 receives the ultra-wideband MAC transmit data from the MAC transmitter 402, converts the ultra-wideband MAC transmit data into PLCP processor data in a format of ultra-wideband PHY protocol data unit (PHY PPDU) frame as shown in FIG. 6, and sends the PLCP processor data to the scrambling part (i.e., a frequency band converter) 406.

The scrambling part 406 receives the PLCP processor data from the PLCP processing part 404, converts the PLCP processor data into a random code sequence, and sends the resultant scrambled data to the encoding part 408.

Meanwhile, the encoder 408 includes a Reed-Solomon (RS) encoder 408a and a convolution encoder 408b to encode the scrambled data. The RS encoder 408a receives the scrambled data from the scrambling part 406, and RS-encodes the scrambled data in order to normally correct a burst error resulting from instantaneous noise, and sends the RS-encoded data to the convolution encoder 408b. The convolution encoder 408b receives the RS-encoded data from the RS encoder 408a, convolution-encodes the RS-encoded data to normally correct a random error, and sends the convolution-encoded data to the puncturing part 410.

The puncturing part 410 receives the convolution-encoded data from the encoding part 408, performs a puncturing function to regularly omit a portion of the convolution-encoded data in accordance with a transmission speed and to thereby increase a code rate, and sends the punctured data into the interleaving part 412.

The interleaving part 412 receives the punctured data from the puncturing part 410, performs a bit interleaving function of rearranging an order of a symbol sequence and a data sequence in a certain unit in order to normally correct the burst error resulting from the instantaneous noise, and sends the interleaved data to the modulating part 414.

The modulating part 414 receives the interleaved data from the interleaving part 412, performs Quadrature Phase Shift Keying (QPSK) modulation in a transmission speed of, for example, 53.3 to 200 Mbps, and performs Dual Carrier Modulation (DCM) in a transmission speed of, for example, 320 to 480 Mbps, and sends the resultant modulated data to the converting part 416.

The converting part 416 receives the modulated data from the modulating part 414, converts the serial data into parallel data, and then sends the parallel data to the AND operating part 418. That is, a data converter including the PLCP processing part 404, the scrambling part 406, the encoding part 408, the puncturing part 410, the interleaving part 412, the modulating part 414, and the converting part 416 receives the ultra-wideband MAC transmit data from the MAC transmitting part 402, performs PLCP processing, scrambling, encoding, puncturing, interleaving, modulating and converting processes on the ultra-wideband MAC transmit data, and sends the parallel data to the AND operating part 418.

Meanwhile, the AND operating part 418 receives the parallel data from the serial-parallel converting part 416 and the transmit data of, for example, the 384 tone-nulling elements for the heterogeneous wireless station frequency from the MAC transmitting part 402, performs an AND function depending on each of, for example, 384 subcarrier channels, and sends inverse fast Fourier transform (IFFT) input data of, for example, 384 channels to the IFFT part 420.

Then, the IFFT part 420 receives the IFFT input data from the AND operating part 418 and performs IFFT function on the IFFT input data. When, for example, 384 tone-nulling element values for the heterogeneous wireless station frequency are all ones, the IFFT part 420 generates a normal ultra-wideband signal. When, for example, forty two or less of the 384 tone-nulling element values for the heterogeneous wireless station frequency are zeros, the IFFT part 420 reduces an output of the ultra-wideband signal by minimizing transmit signal power within a frequency of a subcarrier corresponding to the zero. Thereafter, the IFFT part 420 sends the IFFT data to the DAC part 422.

The DAC part 422 receives the IFFT data from the IFFT part 420, converts the digital data into an analog signal, and sends the analog signal to the RF transmitting part 424.

The RF transmitting part 424 receives the analog signal from the DAC part 422 and the channel number from the MAC transmitting part 402. After RF-modulating the analog signal, the RF transmitting part 424 converts the analog signal into an ultra-wideband signal operating at a transmission speed of, for example, 53.3 to 480 Mbps in a band of 3.1 to 10.6 GHz, and transmits the ultra-wideband signal via the transmitting and receiving antenna 202. Here, the channel number changes the TFC value so that the ultra-wideband data are shifted to another band of the band group #1 or another band group #2, #3, #4, #5, or #6 to thereby be transmitted to the transmitting and receiving antenna 202.

Thus, with the wireless communication system as described above for preventing interference with a heterogeneous wireless station, it is possible to detect a signal from the heterogeneous wireless station while operating; to reduce an output of an ultra-wideband signal in a specific frequency band when the signal from the heterogeneous wireless station is equal to or greater than a predetermined level; and to shift to another ultra-wideband or another ultra-wideband group in order to prevent interference with a heterogeneous wireless station operating in a frequency band exceeding the specific frequency.

A process of transmitting an ultra-wideband signal in the wireless communication system as described above by receiving a heterogeneous wireless station signal; detecting the heterogeneous wireless station signal through RF modulating, analog-digital converting, fast Fourier transforming, heterogeneous wireless station frequency detecting, and tone-nulling element converting processes; converting the ultra-wideband transmit data into ultra-wideband MAC transmit data; and then avoiding the interference through PLCP processing, scrambling, encoding, puncturing, interleaving, modulating and converting, AND operating, inverse fast Fourier transforming, digital-analog converting, and RF modulating processes will now be described.

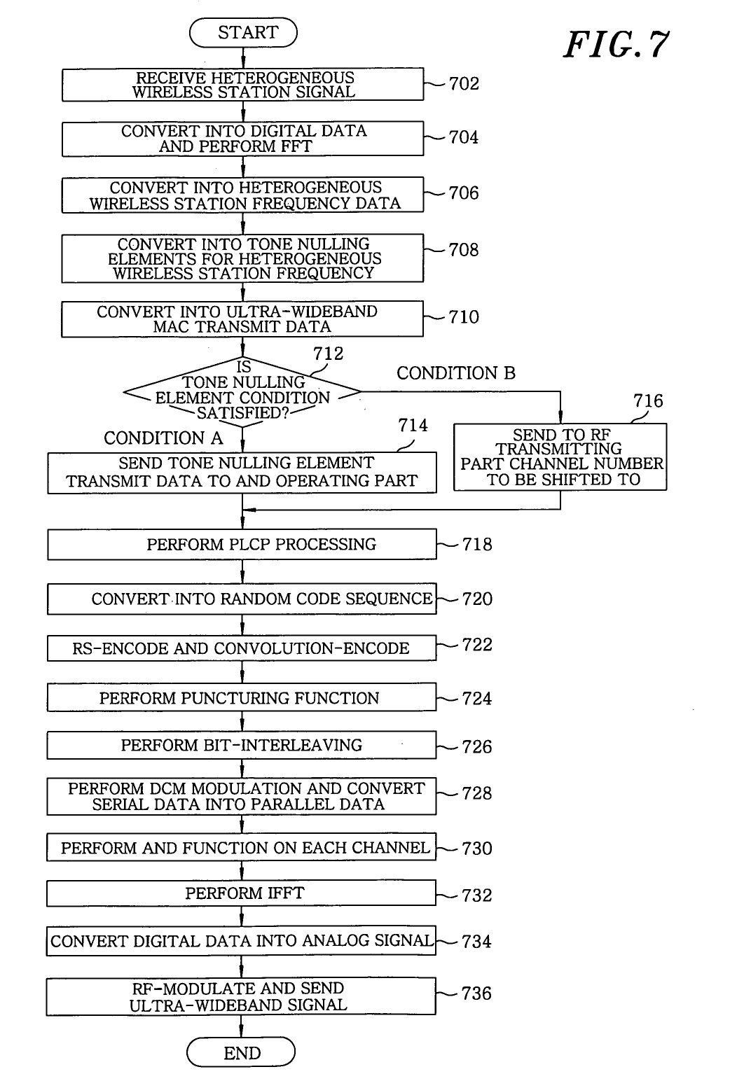

FIG. 7 is a flowchart illustrating a communication process of detecting an ultra-wideband signal and avoiding the interference in accordance with an embodiment of the present invention.

Referring to FIG. 7, a heterogeneous wireless station 100 transmits a heterogeneous wireless station signal, and a transmitting and receiving antenna 202 of the first to n-th detection and avoidance devices 200/1 to 200/n receives the heterogeneous wireless station signal from the heterogeneous wireless station 100 (step 702).

The RF receiving part 302 of the signal detecting unit 204 of the first to n-th detection and avoidance devices 200/1 to 200/n receives the heterogeneous wireless station signal from the transmitting and receiving antenna 202, RF-demodulates the heterogeneous wireless station signal into a baseband analog signal, and sends the signal to the ADC part 304 so that the ADC part 304 converts the analog signal into digital data and the FFT part 306 performs FFT function to thereby send the resultant FFT data to the frequency detecting part 308 (step 704).

Next, the frequency detecting part 308 receives the FFT data from the FFT part 306 and converts the FFT data into heterogeneous wireless station frequency data by converting values of subcarriers corresponding to a heterogeneous wireless station signal equal to or greater than a predetermined, level into zeros and converting values of subcarriers corresponding to a heterogeneous wireless station signal less than the predetermined level into ones with 384 subcarriers in band group #1, so that the heterogeneous wireless station frequency data are transmitted (step 706).

The MAC receiving part 310 converts the heterogeneous wireless station frequency data received from the frequency detecting part 308 into 384 tone-nulling elements for a heterogeneous wireless station frequency in the band group #1 by setting values of tones corresponding to the heterogeneous wireless station signal equal to or greater than a predetermined level to zeros and setting values of tones corresponding to the heterogeneous wireless station signal less than the predetermined level to ones, and sends the 384 tone-nulling elements to the interference avoiding unit 206 (step 708).

Meanwhile, the MAC transmitting part 402 of the interference avoiding unit 206 of the first to n-th detection and avoidance devices 200/1 to 200/n receives the ultra-wideband transmit data from the MAC upper layer and the tone-nulling elements for the heterogeneous wireless station frequency from the MAC receiving part 310, converts the ultra-wideband transmit data into ultra-wideband MAC transmit data, and sends the ultra-wideband MAC transmit data to the PLCP processing part 404 (step 710).

Further, the MAC transmitting part 402 checks a tone-nulling element condition (step 712). If condition A is satisfied, for example, forty two or less of the 384 tone-nulling element values for the heterogeneous wireless station frequency are zeros, the MAC transmitting part 402 converts the tone-nulling elements into tone-nulling element transmit data for the heterogeneous wireless station frequency, and sends the tone-nulling element transmit data to the AND operating part 418 (step 714). If condition B is satisfied, for example, forty three or more of the 384 tone-nulling element values for the heterogeneous wireless station frequency are zeros, the MAC transmitting part 402 generates a channel number corresponding to another band in band group #1 or another band group #2, #3, #4, #5, or #6 to be shifted to, and sends the channel number to the RF transmitting part 424 (step 716).

The PLCP processing part 404 receives the ultra-wideband MAC transmit data from the MAC transmitting part 402, converts the ultra-wideband MAC transmit data into PLCP processor data in a format of an ultra-wideband PHY PPDU frame as shown in FIG. 6, and sends the PLCP processor data to the scrambling part 406 (step 718).

The scrambling part 406 receives the PLCP processor data from the PLCP processing part 404, converts the PLCP processor data into a random code sequence, and sends the scrambled data to the encoding part 408 (step 720).

Meanwhile, in the encoding part 408, the RS encoder 408a RS-encodes the scrambled data from the scrambling part 406 in order to normally correct a burst error resulting from an instantaneous noise, and the convolution encoder 408b convolution-encodes the RS-encoded data in order to normally correct a random error, and then sends the convolution-encoded data to the puncturing part 410 (step 722).

Thus, The puncturing part 410 receives the convolution-encoded data from the encoding part 408, performs a puncturing function to regularly omit a portion of the convolution-encoded data in accordance with a transmission speed and thereby increase a code rate, and sends the punctured data to the interleaving part 412 (step 724).

Further, the interleaving part 412 receives the punctured data from the puncturing part 410, performs bit-interleaving to normally correct a burst error resulting from an instantaneous noise and rearrange an order of a symbol sequence and a data sequence in a certain unit, and sends the interleaved data to the modulating part 414 (step 726).

The modulating part 414 receives the interleaved data from the interleaving part 412, performs Quadrature Phase Shift Keying (QPSK) modulation in a transmission speed of, for example, 53.3 to 200 Mbps, performs Dual Carrier Modulation (DCM) in a transmission speed of for example 320 to 480 Mbps, and sends the resultant modulated data to the converting part 416. The converting part 416 receives the modulated data from the modulating part 414, converts the serial data into parallel data, and sends the parallel data to the AND operating part 418 (step 728).

On the other hand, the AND operating part 418 receives the parallel data from the serial-parallel converting part 416 and the 384 tone-nulling element transmit data for the heterogeneous wireless station frequency from the MAC transmitting part 402, performs an AND function depending on each of 384 subcarrier channels, and sends IFFT input data of the 384 channels to the IFFT part 420 (step 730).

Then, the IFFT part 420 receives the IFFT input data from the AND operating part 418, and performs inverse fast Fourier transform on the IFFT input data. When, for example, 384 tone-nulling element values for the heterogeneous wireless station frequency are all ones, the IFFT part 420 generates a normal ultra-wideband signal. When, for example, forty two or less of the 384 tone-nulling element values for the heterogeneous wireless station frequency are zeros, the IFFT part 420 reduces an output of the ultra-wideband signal by minimizing transmit signal power within a frequency of a subcarrier corresponding to the zero. Thereafter, the IFFT part 420 sends the IFFT data to the DAC part 422 (step 732).

Furthermore, the DAC part 422 receives the IFFT data from the IFFT part 420, converts the digital data into an analog signal, and sends the analog signal to the RF transmitting part 424 (step 734).

Thereafter, the RF transmitting part 424 receives the analog signal from the DAC part 422 and the channel number from the MAC transmitting part 402. The RF transmitting part 424 RF-modulates the analog signal, converts the analog signal into an ultra-wideband signal operating in, for example, a transmission speed of 53.3 to 480 Mbps in a band of 3.1 to 10.6 GHz, and sends the ultra-wideband signal via the transmitting and receiving antenna 202 (step 736). Here, the channel number changes the TFC value so that the ultra-wideband data are shifted to other band of the band group #1 or other band group #2, #3, #4, #5, or #6 to thereby be transmitted to the transmitting and receiving antenna 202.

Thus, the wireless communication system can receive the heterogeneous wireless station signal to thereby detect the heterogeneous wireless station signal, convert the ultra-wideband transmit data into ultra-wideband MAC transmit data, and effectively transmit the ultra-wideband signal while avoiding the interference.

While the invention has been shown and described with respect to the embodiments, it will be understood by those skilled in the art that various changes and modifications may be made without departing from the scope of the invention as defined in the following claims.

What is claimed is:

1. A wireless communication system operating in an ultra-wideband (UWB) communication environment, comprising:
a heterogeneous wireless station for transmitting and receiving a heterogeneous wireless station signal; and
one or more detection and avoidance devices for detecting the heterogeneous wireless station signal while ultra wideband communication operating, and for transmitting and receiving an ultra-wideband signal, the ultra-wideband signal after an output thereof being reduced, or the ultra-wideband signal after being selectively shifted to another ultra-wideband or another ultra-wideband group, in order to prevent interference with the heterogeneous wireless station based on a predetermined level.

2. The system of claim 1, wherein the detection and avoidance device includes:
a transmitting and receiving antenna for receiving the heterogeneous wireless station signal from the heterogeneous wireless station, and for transmitting and receiving the ultra-wideband signal;
a signal detecting unit for receiving the heterogeneous wireless station signal via the transmitting and receiving antenna to thereby detect the heterogeneous wireless station signal, and for converting the heterogeneous wireless station signal into tone-nulling elements for a heterogeneous wireless station frequency based on the predetermined level; and
an interference avoiding unit for receiving the tone-nulling elements, and for, based on values of the tone-nulling elements, generating the ultra-wideband signal as a normal signal to transmit the ultra-wideband signal via the transmitting and receiving antenna; reducing the output of the ultra-wideband signal by minimizing power of a transmit signal at a frequency of a subcarrier via the transmissing and receiving antenna to transmit the ultra-wideband signal via the transmitting and receiving antenna; or changing a time frequency number (TFC) value of the ultra-wideband signal to selectively shift the ultra-wideband signal to said another band in a corresponding band group or said another band group thereby being transmitted via the transmitting and receiving antenna.

3. The system of claim 2, wherein the signal detecting unit has:
a radio frequency (RF) receiving part for receiving the heterogeneous wireless station signal via the transmissing and receiving antenna, and for RF-demodulating the heterogeneous wireless station signal into a baseband analog signal;
an analog-digital converting (ADC) part for receiving the analog signal and converting the analog signal into digital data;
a fast Fourier transforming (FFT) part for receiving the digital data and performing FFT on the digital data;
a frequency detecting part for receiving the fast Fourier transformed data from the FFT part, and for converting the fast Fourier transformed data into heterogeneous wireless station frequency data by selectively setting values of subcarriers corresponding to the heterogeneous wireless station signal based on the predetermined level; and
a MAC receiving part for receiving the heterogeneous wireless station frequency data, selectively setting values of tones for the heterogeneous wireless station signal based on the predetermined level, converting the heterogeneous wireless station frequency data into the tone-nulling elements, and then sending the tone-nulling elements to the interference avoiding unit.

4. The system of claim 2, wherein the interference avoiding unit has:
a MAC transmitting part for receiving ultra-wideband transmit data from an MAC upper layer and the tone-nulling elements from the MAC receiving part, for converting the ultra-wideband transmit data into ultra-wideband MAC transmit data, and, based on values of the tone-nulling elements, for converting the tone-nulling elements into transmit data of the tone-nulling elements for the heterogeneous wireless station frequency to send the transmit data, or generating and sending a channel number corresponding to said another band in the band group or said another band group to be shifted to;
a data converting part for receiving the ultra-wideband MAC transmit data and performing PLCP processing, scrambling, encoding, puncturing, interleaving, modulating and conversing processes on the ultra-wideband MAC transmit data;
an AND operating part for receiving parallel data from the data converting part and the transmit data of the tone-nulling elements from the MAC transmitting part, and for performing an AND function depending on each subcarrier channel;
an inverse fast Fourier transforming (IFFT) part for receiving IFFT input data from the AND operating part, performing IFFT on the IFFT input data, and generating the ultra-wideband signal or reducing the output of the ultra-wideband signal by minimizing transmit signal power at a frequency of a subcarrier based on the values of the tone-nulling element;
a digital-analog converting (DAC) part for receiving the IFFT data from the IFFT part and converting the digital data into an analog signal; and
an RF transmitting part for receiving the analog signal and the channel number from the MAC transmitting part, for RF-modulating the analog signal, converting the RF-modulated analog signal into the ultra-wideband signal based on a frequency band and a transmission speed, and transmitting the ultra-wideband signal via the transmitting and receiving antenna, and for using the channel number to change the TFC value so that the ultra-wideband data are shifted to said another band of the band group or said another band group to thereby be transmitted via the transmitting and receiving antenna.

5. The system of claim 3, wherein the interference avoiding unit has:
a MAC transmitting part for receiving ultra-wideband transmit data from an MAC upper layer and the tone-nulling elements from the MAC receiving part, for converting the ultra-wideband transmit data into ultra-wideband MAC transmit data, and, based on values of the tone-nulling elements, for converting the tone-nulling elements into transmit data of the tone-nulling elements for the heterogeneous wireless station frequency to send the transmit data, or generating and sending a channel number corresponding to said another band in the band group or said another band group to be shifted to;
a data converting part for receiving the ultra-wideband MAC transmit data and performing PLCP processing, scrambling, encoding, puncturing, interleaving, modulating and conversing processes on the ultra-wideband MAC transmit data;
an AND operating part for receiving parallel data from the data converting part and the transmit data of the tone-nulling elements from the MAC transmitting part, and for performing an AND function depending on each subcarrier channel;
an inverse fast Fourier transforming (IFFT) part for receiving IFFT input data from the AND operating part, performing IFFT on the IFFT input data, and generating the ultra-wideband signal or reducing the output of the ultra-wideband signal by minimizing transmit signal power at a frequency of a subcarrier based on the values of the tone-nulling element;
a digital-analog converting (DAC) part for receiving the IFFT data from the IFFT part and converting the digital data into an analog signal; and
an RF transmitting part for receiving the analog signal and the channel number from the MAC transmitting part, for RF-modulating the analog signal, converting the RF-modulated analog signal into the ultra-wideband signal based on a frequency band and a transmission speed, and transmitting the ultra-wideband signal via the transmitting and receiving antenna, and for using the channel number to change the TFC value so that the ultra-wideband data are shifted to said another band of the band group or said another band group to thereby be transmitted via the transmitting and receiving antenna.

6. The system of claim 4, wherein the data converter has:
a PLCP processor for receiving the ultra-wideband MAC transmit data, and converting the ultra-wideband MAC transmit data into PLCP processor data in a format of an ultra-wideband PHY Protocol Data Unit (PHY PPDU) frame;
a scrambler for receiving the PLCP processor data and converting the PLCP processor data into a random code sequence;
an encoder for Reed-Solomon (RS)-encoding and convolution-encoding the scrambled data from the scrambler;
a puncturer for receiving the encoded data from the encoder, and performing a puncturing function to increase a code rate by regularly omitting a portion of the convolution-encoded data depending on a transmission speed;
an interleaver for receiving the punctured data from the puncturer, and performing a bit-interleaving function to arrange an order of a symbol sequence and a data sequence in a predetermined unit in order to normally correct a burst error resulting from an instantaneous noise;
a modulator for receiving interleaved data from the interleaver and performing a Quadrature Phase Shift Keying (QPSK) modulation function or a Dual Carrier Modulation (DCM) function depending on the transmission speed; and
a converter for receiving the modulated data from the modulator and converting the serial data into parallel data.

7. The system of claim 5, wherein the data converter has:
a PLCP processor for receiving the ultra-wideband MAC transmit data, and converting the ultra-wideband MAC transmit data into PLCP processor data in a format of an ultra-wideband PHY Protocol Data Unit (PHY PPDU) frame;
a scrambler for receiving the PLCP processor data and converting the PLCP processor data into a random code sequence;
an encoder for Reed-Solomon (RS)-encoding and convolution-encoding the scrambled data from the scrambler;
a puncturer for receiving the encoded data from the encoder, and performing a puncturing function to increase a code rate by regularly omitting a portion of the convolution-encoded data depending on a transmission speed;
an interleaver for receiving the punctured data from the puncturer, and performing a bit-interleaving function to arrange an order of a symbol sequence and a data sequence in a predetermined unit in order to normally correct a burst error resulting from an instantaneous noise;
a modulator for receiving interleaved data from the interleaver and performing a Quadrature Phase Shift Keying (QPSK) modulation function or a Dual Carrier Modulation (DCM) function depending on the transmission speed; and
a converter for receiving the modulated data from the modulator and converting the serial data into parallel data.

8. The system of claim 6, wherein the encoder has:
an RS encoder for receiving the scrambled data and RS-encoding the scrambled data to normally correct the burst error resulting from the instantaneous noise; and
a convolution encoder for receiving the RS-encoded data from the RS encoder and convolution-encoding the RS-encoded data to normally correct a random error.

9. The system of claim 7, wherein the encoder has:
an RS encoder for receiving the scrambled data and RS-encoding the scrambled data to normally correct the burst error resulting from the instantaneous noise; and
a convolution encoder for receiving the RS-encoded data from the RS encoder and convolution-encoding the RS-encoded data to normally correct a random error.

10. A communication method in a wireless communication system in an ultra-wideband (UWB) communication environment, the method comprising:
receiving a heterogeneous wireless station signal from a heterogeneous wireless station to detect the heterogeneous wireless station signal;
converting the heterogeneous wireless station signal into tone-nulling elements for a frequency of the heterogeneous wireless station signal based on a predetermined level, corresponding to the UWB communication environment;
receiving the tone-nulling elements, and then, based on values of the tone-nulling elements, generating an ultra-wideband signal as a normal signal to transmit the ultra-wideband signal via a transmitting and receiving antenna, or reducing an output of the ultra-wideband signal by minimizing transmit signal power at a frequency of a subcarrier to transmit the ultra-wideband signal having the reduced output via the transmitting and receiving antenna; and
changing a time frequency number (TFC) of the ultra-wideband signal based on the values of the tone-nulling elements to selectively shift the ultra-wideband signal to another band of a corresponding band group or another band group to transmit the ultra-wideband signal.

11. The method of claim 10, wherein the receiving the heterogeneous wireless station signal includes:
RF-demodulating the heterogeneous wireless station signal into a baseband analog signal;
converting the RF-demodulated analog signal into digital data;
performing fast Fourier transform (FFT) function on the digital data; and
converting the FFT data into heterogeneous wireless station frequency data by selectively setting values of subcarriers corresponding to the heterogeneous wireless station signal based on the predetermined level.

12. The method of claim 11, wherein the converting the heterogeneous wireless station signal selectively sets values of tones for the heterogeneous wireless station signal based on the predetermined level, and then converting the heterogeneous wireless station frequency data into the tone-nulling elements for the heterogeneous wireless station frequency.

13. The method of claim 11, wherein the receiving the tone-nulling elements includes:
receiving ultra-wideband transmit data from an MAC upper layer and the tone-nulling elements;
converting the ultra-wideband transmit data into ultra-wideband MAC transmit data; and converting the tone-nulling elements into transmit data of tone-nulling elements to send the transmit data of tone-nulling elements or generating and sending a channel number corresponding to said another band in the band group or said another band group to be shifted to based on the values of the tone-nulling element;
performing PLCP processing, scrambling, encoding, puncturing, interleaving, modulating and conversing processes on the ultra-wideband MAC transmit data;
receiving the transmit data of the tone-nulling elements and performing an AND function depending on each subcarrier channel;
performing inverse fast Fourier transform (IFFT) on the IFFT input data, and generating the ultra-wideband signal or reducing the output of the ultra-wideband signal by minimizing transmit signal power at a frequency of a subcarrier based on the values of the tone-nulling elements; and
converting the digital data into an analog signal, RF-modulating the analog signal through the channel number, converting the analog signal into the ultra-wideband signal based on a frequency band and a transmission speed, and transmitting the ultra-wideband signal.

14. The method of claim 12, wherein the receiving the tone-nulling elements includes:
receiving ultra-wideband transmit data from an MAC upper layer and the tone-nulling elements;
converting the ultra-wideband transmit data into ultra-wideband MAC transmit data; and converting the tone-nulling elements into transmit data of tone-nulling elements to send the transmit data of tone-nulling elements or generating and sending a channel number corresponding to said another band in the band group or said another band group to be shifted to based on the values of the tone-nulling element;
performing PLCP processing, scrambling, encoding, puncturing, interleaving, modulating and conversing processes on the ultra-wideband MAC transmit data;
receiving the transmit data of the tone-nulling elements and performing an AND function depending on each subcarrier channel;
performing inverse fast Fourier transform (IFFT) on the IFFT input data, and generating the ultra-wideband signal or reducing the output of the ultra-wideband signal by minimizing transmit signal power at a frequency of a subcarrier based on the values of the tone-nulling elements; and
converting the digital data into an analog signal, RF-modulating the analog signal through the channel number, converting the analog signal into the ultra-wideband signal based on a frequency band and a transmission speed, and transmitting the ultra-wideband signal.

15. The method of claim 13, wherein the changing a time frequency number uses the channel number to change the TFC value so that the ultra-wideband data are shifted to said another band of the band group or said another band group to thereby be transmitted.

16. The method of claim 14, wherein the changing a time frequency number uses the channel number to change the TFC value so that the ultra-wideband data are shifted to said another band of the band group or said another band group to thereby be transmitted.
